(19) United States
(12) Patent Application Publication
(10) Pub. No.: US 2018/0274497 A1
(43) Pub. Date: Sep. 27, 2018

(54) ENGINE HAVING EGR COOLER

(71) Applicants: HYUNDAI MOTOR COMPANY, Seoul (KR); KIA MOTORS CORPORATION, Seoul (KR)

(72) Inventors: Won Rok CHOI, Seoul (KR); Si Hyuk RYU, Seongnam-si (KR); Seung Jae KANG, Seoul (KR)

(21) Appl. No.: 15/792,495

(22) Filed: Oct. 24, 2017

(30) Foreign Application Priority Data
Mar. 27, 2017 (KR) 10-2017-0038420

(51) Int. Cl. F02M 26/29; F02M 26/20

(52) U.S. Cl. CPC F02M 26/29; F02M 26/20

(57) ABSTRACT

An engine having an exhaust gas recirculation (EGR) cooler includes: a high-pressure EGR cooler; an intake manifold which has an intake inlet which is supplied with intake gas, a high-pressure EGR inlet which is supplied with high-pressure EGR gas, a connecting hole which delivers the supplied high-pressure EGR gas to the high-pressure EGR cooler, and a distribution hole which is supplied with the high-pressure EGR gas cooled by the high-pressure EGR cooler; and a high-pressure EGR valve which is disposed on the intake manifold, and controls a flow of the high-pressure EGR gas delivered from the intake manifold to the high-pressure EGR cooler.

### CROSS-REFERENCE TO RELATED APPLICATION

This application claims the benefit of priority to Korean Patent Application No. 10-2017-0038420 filed in the Korean Intellectual Property Office on Mar. 27, 2017, the entire content of which is incorporated herein by reference.

### TECHNICAL FIELD

The present disclosure relates to an engine having an exhaust gas recirculation (EGR) cooler which recirculates exhaust gas from an exhaust line to an intake line and cools the recirculating exhaust gas in order to reduce nitrogen oxide generated during combustion.

### BACKGROUND

In general, exhaust gas from a vehicle contains hazardous substances such as carbon monoxide (CO), nitrogen oxide (NOx), and hydrocarbon (HC), and among the three substances generated during combustion, the nitrogen oxide has an opposite causal relationship with the carbon monoxide and the hydrocarbon. That is, a large amount of nitrogen oxide is generated at a point in time at which the amount of carbon monoxide and the amount of hydrocarbon are decreased within a practical output range. The amount of generated nitrogen oxide is increased as fuel is completely combusted and a temperature of an engine is increased. A permissible amount of exhaust gas such as nitrogen oxide is restricted by related regulations, and thus various technologies have been developed to reduce exhaust gas.

One of the technologies is an exhaust gas recirculation (EGR) apparatus. The exhaust gas recirculation (EGR) apparatus maintains a mixture ratio to a theoretical air-fuel ratio in order to reduce the amount of generated nitrogen oxide without greatly increasing other hazardous substances, reduces the amount of fresh air by supplying a part of combustion gas (EGR gas) into a gas mixture introduced into a combustion chamber, and lowers a temperature of flame of combustion gas.

A configuration of the exhaust gas recirculation apparatus includes an EGR pipe through which a part of exhaust gas discharged from an exhaust manifold is recirculated to an intake manifold, and a control valve which is positioned at a predetermined position of the EGR pipe and adjusts the amount of circulating exhaust gas. In particular, the configuration of the exhaust gas recirculation apparatus includes an EGR cooler which cools exhaust gas introduced through the control valve and supplies the cooled exhaust gas to the intake manifold.

Meanwhile, because of a connection structure between the EGR cooler and the EGR pipe, a layout is complicated, a weight may be increased, and responsiveness may deteriorate because an EGR gas circulation line is lengthened. Therefore, researches are being conducted on a structure capable of simplifying a layout, reducing a weight, and improving responsiveness.

The above information disclosed in this Background section is only for enhancement of understanding the background of the invention and therefore it may contain information that does not form the prior art that is already known in this country to a person of ordinary skill in the art.

### SUMMARY

The present disclosure has been made in an effort to provide an engine having an EGR cooler which is installed in an intake manifold, thereby simplifying a layout, reducing a weight, and improving responsiveness.

According to an exemplary embodiment of the present disclosure, an engine having an EGR cooler includes: a high-pressure EGR cooler; an intake manifold which has an intake inlet which is supplied with intake gas, a high-pressure EGR inlet which is supplied with high-pressure EGR gas, a connecting hole which delivers the supplied high-pressure EGR gas to the high-pressure EGR cooler, and a distribution hole which is supplied with the high-pressure EGR gas cooled by the high-pressure EGR cooler; and a high-pressure EGR valve which is disposed on the intake manifold, and controls a flow of the high-pressure EGR gas delivered from the intake manifold to the high-pressure EGR cooler.

The engine having the EGR cooler may further include a distribution pipe which is inserted into the distribution hole, and mixes the high-pressure EGR gas with the intake gas.

An opening, which is opened in a direction in which the intake gas flows, may be formed in the distribution pipe.

The high-pressure EGR cooler may be made of an aluminum material.

The engine having the EGR cooler may further include coolant inlet and outlet pipes which supplies and discharges a coolant to and from the high-pressure EGR cooler and the high-pressure EGR valve, respectively.

Low-pressure EGR gas may be mixed with the intake gas to be delivered to the intake manifold.

The engine having the EGR cooler may further include an intake control valve which is installed in the intake inlet of the intake manifold so as to control the amount of intake gas.

The high-pressure EGR cooler may be disposed at one side of an upper side of the intake manifold.

The high-pressure EGR valve may be disposed at the other side of the upper side of the intake manifold.

According to another exemplary embodiment of the present disclosure, an engine having an EGR cooler includes: an intake manifold which is disposed on a cylinder head, and has an EGR inlet which is supplied with high-pressure EGR gas from the cylinder head, a plurality of intake ports which delivers a gas mixture to the engine through the cylinder head, and an intake inlet into which intake gas is introduced; and a high-pressure EGR cooler which is connected directly to the intake manifold, is supplied with the high-pressure EGR gas, which is delivered to the intake manifold, through a connecting hole formed in the intake manifold, and delivers the high-pressure EGR gas to a distribution hole formed in the intake manifold.

The engine having the EGR cooler may further include a distribution pipe which is inserted into the distribution hole, and mixes the high-pressure EGR gas with the intake gas.

An opening, which is opened in a direction in which fresh air flows, may be formed at a tip of the distribution pipe which is inserted into the intake manifold.

According to the exemplary embodiments of the present disclosure, the EGR cooler is mounted on the intake manifold, and the EGR cooler is supplied with the EGR gas through the intake manifold, such that a layout may be simplified, a weight may be reduced, and responsiveness may also be improved. That is, the high-pressure EGR valve and the high-pressure EGR cooler are mounted directly on the intake manifold, the intake manifold is supplied with the high-pressure EGR gas directly from the cylinder head, and the cooled high-pressure EGR gas is distributed directly to the intake manifold, and as a result, EGR pipes for delivering the high-pressure EGR gas may be removed or minimized, responsiveness in controlling the EGR gas may be improved, a weight and production costs may be reduced, and productivity may be improved.

### BRIEF DESCRIPTION OF THE DRAWINGS

FIGS. 1 and 2 are perspective views illustrating a part of an engine having an EGR cooler according to an exemplary embodiment of the present disclosure.

FIG. 3 is an exploded perspective view illustrating a part of the engine having the EGR cooler according to an exemplary embodiment of the present disclosure.

FIG. 4 is a partial perspective view illustrating structures of an intake manifold and a distribution pipe according to an exemplary embodiment of the present disclosure.

FIG. 5 is a perspective view of the distribution pipe mounted in the intake manifold according to an exemplary embodiment of the present disclosure.

### DETAILED DESCRIPTION OF THE EMBODIMENTS

Hereinafter, exemplary embodiments of the present disclosure will be described in detail with reference to the accompanying drawings.

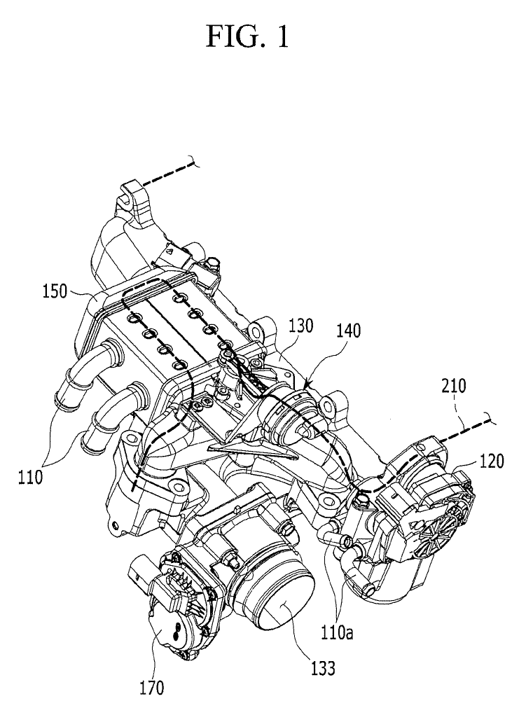

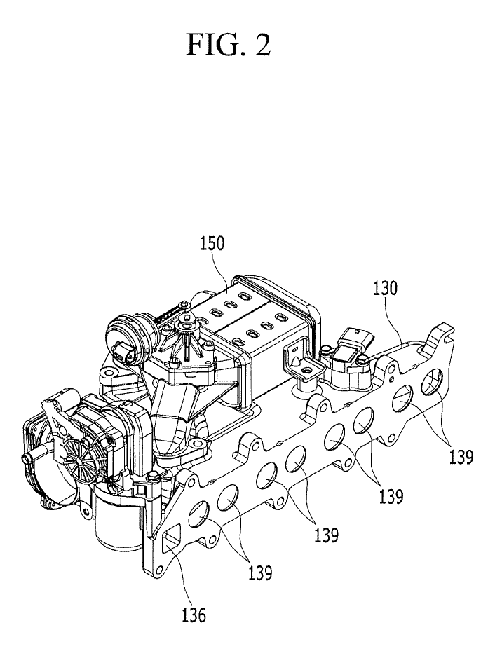

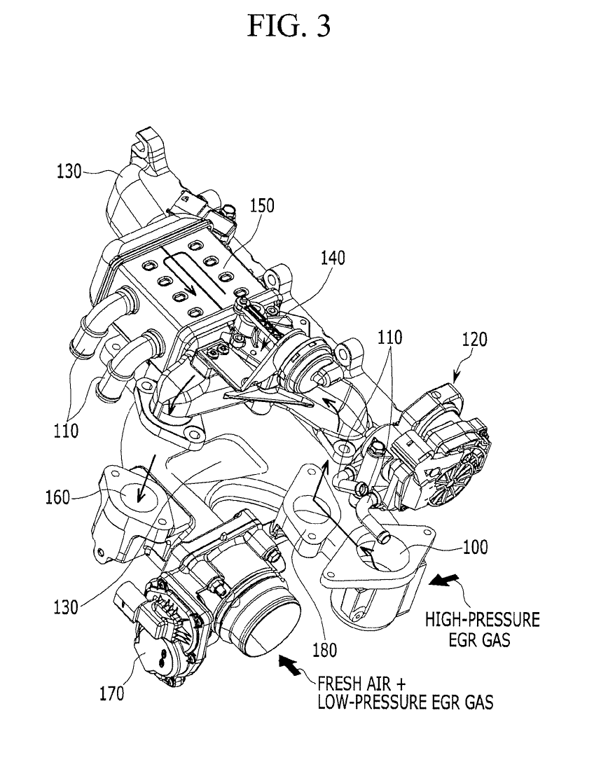

The size and thickness of each component illustrated in the drawings are arbitrarily shown for understanding and ease of description, but the present disclosure is not limited thereto. Thicknesses of several portions and regions are enlarged for clearly describing the above. Parts irrelevant to the description will be omitted to clearly describe the exemplary embodiments of the present disclosure, and the same or similar constituent elements will be designated by the same reference numerals throughout the specification. In the following description, names of constituent elements are classified as a first . . . , a second . . . , and the like so as to discriminate the constituent elements having the same name, and the names are not essentially limited to the order in the description below. FIGS. 1 and 2 are perspective views illustrating a part of an engine having an EGR cooler according to an exemplary embodiment of the present disclosure, and FIG. 3 is an exploded perspective view illustrating a part of the engine having the EGR cooler according to the exemplary embodiment of the present disclosure.

Referring to FIGS. 1 to 3, an engine having an EGR cooler according to an exemplary embodiment of the present disclosure includes an intake manifold 130, a high-pressure EGR cooler 150, a high-pressure EGR bypass valve 140, and a high-pressure EGR valve 120. Fresh air or a mixture of fresh air and low-pressure EGR gas is supplied to the intake manifold 130 through an intake inlet 133.

In addition, the intake manifold 130 has a high-pressure EGR inlet 136 into which high-pressure EGR gas is introduced, and the high-pressure EGR gas is delivered to the high-pressure EGR cooler 150.

The high-pressure EGR cooler 150 is mounted at an upper side of the intake manifold 130, is supplied with the high-pressure EGR gas through the intake manifold 130, cools the high-pressure EGR gas, and delivers the cooled high-pressure EGR gas back to the intake manifold 130.

Further, the high-pressure EGR bypass valve 140 is mounted on the high-pressure EGR cooler 150 so as to bypass the high-pressure EGR cooler 150.

The high-pressure EGR valve 120 is mounted on the intake manifold 130 in order to control a flow of the high-pressure EGR gas supplied through a cylinder head 210 (see FIG. 3). The high-pressure EGR valve 120 is mounted on the intake manifold 130 through a valve hole 100 formed in the intake manifold 130. Here, the high-pressure EGR valve 120 communicates with high-pressure EGR valve cooling inlet and outlet pipes 110a so as to be cooled by a coolant.

A connecting hole 180 is formed in the intake manifold 130, and the high-pressure EGR gas is delivered to the high-pressure EGR cooler 150 through the connecting hole 180.

Referring to FIGS. 1 and 3, the high-pressure EGR cooler 150 has a U-shaped flow path, is connected to coolant inlet and outlet pipes 110, cools the high-pressure EGR gas by using the coolant, and includes fins and tubes made of an aluminum material.

Because the structures of the fins and the tubes and the U-shaped flow path are technologies applied to a general EGR cooler, a specific description thereof will be omitted. A distribution hole 160 is formed in the intake manifold 130, and the distribution hole 160 is supplied with the high-pressure EGR gas cooled by the high-pressure EGR cooler 150. As described above, the intake manifold 130 is formed integrally with the high-pressure EGR inlet 136 which is supplied with the high-pressure EGR gas, the valve hole 100 in which the high-pressure EGR valve 120 is mounted, the connecting hole 180 which is connected to the high-pressure EGR cooler 150, and the distribution hole 160 which is supplied with the high-pressure EGR gas cooled by the high-pressure EGR cooler 150. The high-pressure EGR cooler 150 is mounted directly on the intake manifold 130. Here, the high-pressure EGR inlet 136 of the intake manifold 130, which is supplied with the high-pressure EGR gas, is connected directly to the cylinder head 210. In the present disclosure, a passageway for the high-pressure EGR gas is formed in the cylinder head 210, and this passageway may be connected to the high-pressure EGR inlet 136 of the intake manifold 130. As described above, the high-pressure EGR valve 120 and the high-pressure EGR cooler 150 are mounted directly on the intake manifold 130, and the intake manifold 130 is supplied with the high-pressure EGR gas directly from the cylinder head 210.

Since the cooled high-pressure EGR gas is supplied directly to the intake manifold 130, EGR pipes for delivering the high-pressure EGR gas may be removed or minimized, responsiveness in controlling the EGR gas may be improved, a weight and production costs may be reduced, and productivity may be improved.

In the present disclosure, intake gas, which is delivered to the intake manifold, may be fresh air or a gas mixture of fresh air and low-pressure EGR gas, and an intake control valve 170 may control the amount of intake gas to be introduced through the intake inlet 133.

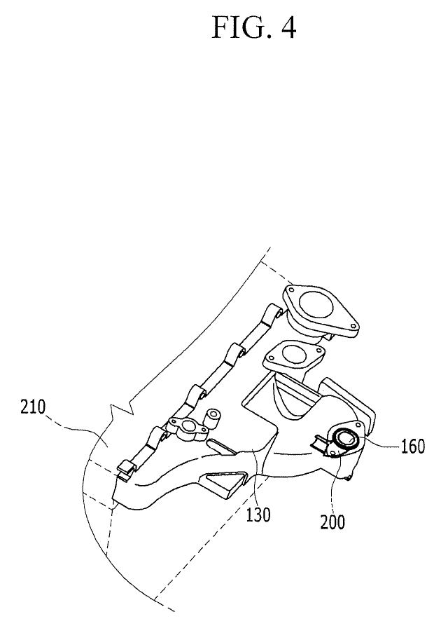

FIG. 4 is a partial perspective view illustrating structures of the intake manifold and the distribution pipe according to the exemplary embodiment of the present disclosure.

Referring to FIGS. 2 and 4, the intake manifold 130 is mounted on the cylinder head 210 of the engine, and distributes the intake gas and the EGR gas to combustion chambers through a plurality of intake ports 139 formed in the intake manifold 130. In addition, the distribution hole 160, which is supplied with the high-pressure EGR gas from the high-pressure EGR cooler 150, is formed at one side of the intake manifold 130, and a distribution pipe 200 is mounted by being inserted into the distribution hole 160.

An opening 300 is formed at a tip portion of the distribution pipe 200 which is inserted into the intake manifold 130. The opening 300 is opened in a direction in which the intake gas flows, and closed in a direction in which the intake gas is introduced.

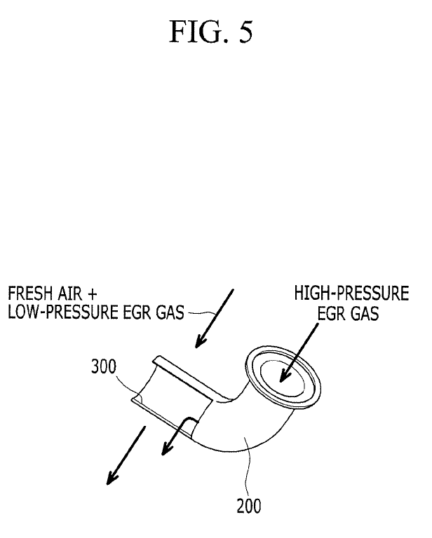

FIG. 5 is a perspective view of the distribution pipe mounted in the intake manifold according to the exemplary embodiment of the present disclosure.

Referring to FIG. 5, a tip of the distribution pipe 200 is disposed in a direction perpendicular to the direction in which the intake gas flows, a portion of the distribution pipe 200 where the intake gas is introduced is closed, and a portion opposite to the portion of the distribution pipe 200 where the intake gas is introduced is opened through the opening 300.

With this structure, intake efficiency of the supplied high-pressure EGR gas may be improved, and mixing properties of the intake gas and the EGR gas may be improved.

In addition, the distribution pipe 200 prevents a reverse flow of the EGR gas, thereby preventing contamination of the intake control valve 170.

While this invention has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims.

What is claimed is:

1. An engine having an exhaust gas recirculation (EGR) cooler, the engine comprising:
a high-pressure EGR cooler;
an intake manifold comprising:
an intake inlet which is supplied with intake gas;
a high-pressure EGR inlet which is supplied with high-pressure EGR gas;
a connecting hole which delivers the supplied high-pressure EGR gas to the high-pressure EGR cooler; and
a distribution hole which is supplied with the high-pressure EGR gas cooled by the high-pressure EGR cooler; and
a high-pressure EGR valve which is disposed on the intake manifold and controls a flow of the high-pressure EGR gas delivered from the intake manifold to the high-pressure EGR cooler.

2. The engine of claim 1, further comprising:
a distribution pipe which is inserted into the distribution hole and mixes the high-pressure EGR gas with the intake gas.

3. The engine of claim 2, wherein:
the distribution pipe has an opening which is opened in a direction in which the intake gas flows.

4. The engine of claim 1, wherein:
the high-pressure EGR cooler is made of an aluminum material.

5. The engine of claim 1, further comprising:
coolant inlet and outlet pipes which supply and discharge a coolant to and from the high-pressure EGR cooler and the high-pressure EGR valve, respectively.

6. The engine of claim 1, wherein:
low-pressure EGR gas is mixed with the intake gas to be delivered to the intake manifold.

7. The engine of claim 6, further comprising:
an intake control valve which is disposed in the intake inlet of the intake manifold and controls the amount of intake gas.

8. The engine of claim 1, wherein:
the high-pressure EGR cooler is disposed at one side of an upper side of the intake manifold.

9. The engine of claim 8, wherein:
the high-pressure EGR valve is disposed at another side of the upper side of the intake manifold.

10. An engine having an EGR cooler, the engine comprising:
an intake manifold which is disposed on a cylinder head, the intake manifold having:
an EGR inlet which is supplied with high-pressure EGR gas from the cylinder head;
a plurality of intake ports which delivers a gas mixture to the engine through the cylinder head; and
an intake inlet into which intake gas is introduced; and
a high-pressure EGR cooler which is connected directly to the intake manifold, is supplied with the high-pressure EGR gas, which is delivered to the intake manifold, through a connecting hole formed in the intake manifold, and delivers the high-pressure EGR gas to a distribution hole formed in the intake manifold.

11. The engine of claim 10, further comprising:
a distribution pipe which is inserted into the distribution hole and mixes the high-pressure EGR gas with the intake gas.

12. The engine of claim 11, wherein:
an opening, which is opened in a direction in which fresh air flows, is formed at a tip of the distribution pipe which is inserted into the intake manifold.
